(19) United States
(12) Patent Application Publication
(10) Pub. No.: US 2022/0228651 A1
(43) Pub. Date: Jul. 21, 2022

(54) CONTINUOUSLY VARIABLE TRANSMISSION SYSTEM

(71) Applicant: Shark Wheel, Inc., Lake Forest, CA (US)

(72) Inventor: Ibrahim Mesinovic, Lerum (SE)

(21) Appl. No.: 17/152,586

(22) Filed: Jan. 19, 2021

(51) Int. Cl. F16H 9/20; B60K 17/08

(52) U.S. Cl. CPC F16H 9/20; B60K 17/08

(57) ABSTRACT

A continuously variable transmission system having a first adjustable pulley and a second adjustable pulley, a belt being around an outer surface of both the first and the second pulley, and a CPU programed to signal a motor to adjust the first adjustable pulley and second adjustable pulley according to a user input is provided.

### BACKGROUND OF INVENTION

### 1. Field of the Invention:

The invention relates generally to transmissions and more specifically to continuously variable transmissions.

### 2. Description of the Related Art

Currently, motors utilizing gear transmissions usually have to change gears while operating, which causes a rough ride. The rough ride is caused by the gears shifting within the transmission and leads to a jerking motion while in the vehicle. These motor and transmission combinations also have a large heat build-up because of the constant changing of gears, which can destroy the motor components over time. Additionally, current continuously variable transmissions (CVT) are controlled by centrifugal force and need high rotations per minute to function, thus cannot operate in numerous situations. Moreover, CVT motors usually cannot operate in manual (non-electric) mode. Motors utilizing a CVT transmission system also are known to cause battery life issues due to the increase of heat in the system. Similarly, current motors utilizing a CVT transmission systems cannot adapt to non-adjusting components, such as a pulley not adjusting to the correct diameter for the gear like setting.

Therefore, there is a need to solve the problems described above by proving a device and system for motor improvement.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a continuously variable transmission system having a first adjustable pulley and a second adjustable pulley, a belt being around an outer surface of both the first adjustable pulley and the second adjustable pulley, and a CPU programed to signal a motor to adjust a first disk and a second disk, wherein both the first disk and the second disk rotate, thus adjusting the first adjustable pulley and second adjustable pulley is provided. The CPU having preset modes created by a user input is also provided. Thus, an advantage is an easily adjustable CVT system. Additionally, another advantage is easily correcting the pulley diameter by the CPU signals to the first and second disks.

In another aspect, a continuously variable transmission system having a first threaded rod, coupled to the first disk, adapted to adjust the first adjustable pulley and a second threaded rod, coupled to the second disk, adapted to adjust the second adjustable pulley is provided. Thus, an advantage is longevity of the CVT system components due to the CPU immediately adjusting the first and second disks, and in turn the rods, for the pulleys to be the proper diameter for the desired motion of the vehicle. Moreover, another advantage is a smoother ride due to pulleys efficiently adjusting to the proper diameter.

In another aspect, a continuously variable transmission system having various preset input modes for the CPU is provided. Thus, an advantage is more efficient travel depending on the type of terrain the vehicle is on, such as a high-speed preset, which allows the CPU to immediately send signals to adjust the pulleys to the appropriate diameter. Additionally, the presets allow for a smoother ride on the various terrains.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates the perspective view of a continuously variable transmission (CVT) system, according to an aspect.

FIG. 2 illustrates the side perspective view of a continuously variable transmission (CVT) system, according to an aspect.

FIG. 3 illustrates the side perspective view of a continuously variable transmission (CVT) system, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

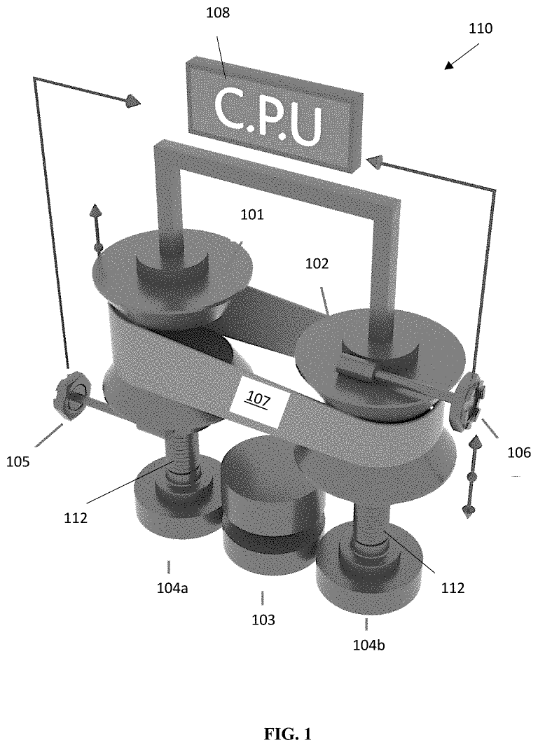

FIG. 1 illustrates the perspective view of a continuously variable transmission (CVT) system 110, according to an aspect. The CVT system 110 having a first pulley (“first adjustable pulley,” “pulley”) 101, a second pulley (“second adjustable pulley,” “pulley”) 102 and a motor 103, is provided. The first and second pulley being adjustable, meaning the diameter for each pulley 101,102 may be variable. The first pulley 101 may be a primary pulley, which may be directly connected to a motor via a driveshaft 105. For example, the motor connected to the driveshaft 105 may be a car motor, scooter motor, or other applicable motor. The second pulley 102 may be a driven pulley, which may be connected to wheels via a driveshaft 106. For example, the wheels connected to the driveshaft 106 may any wheels for the corresponding motor. Additionally, the pulleys 101 and 102 change diameter to allow for a smooth gear transition. A belt 107 may be used to attach each of the pulleys 101, 102, for example, the belt 107 may be around an outer surface of both the first and the second pulley 101,102. The belt 107 allowing for the rotation in the pulleys 101 and 102 with changing diameters. Furthermore, the gear ratio is changed when the motor 103 rotates threaded rods 104. The threaded rods 112 rotated by the outer disk 104a in pulley 101 and the inner disk 104b in pulley 102 may allow the diameter to change on both pulleys 101 and 102 simultaneously. Thus, allowing the belt 107 to rotate pulley 102 faster or slower depending on the CVT mode (“CVT preset”), such as a speed mode or torque mode (“high torque preset”). Moreover, the threaded rods 112 may have threading in opposite directions, which may allow each pulley to change diameter simultaneously. For example, the first pulley 101 may be adjusted to a larger diameter, while the second pulley 102 may be adjusted to a smaller diameter.

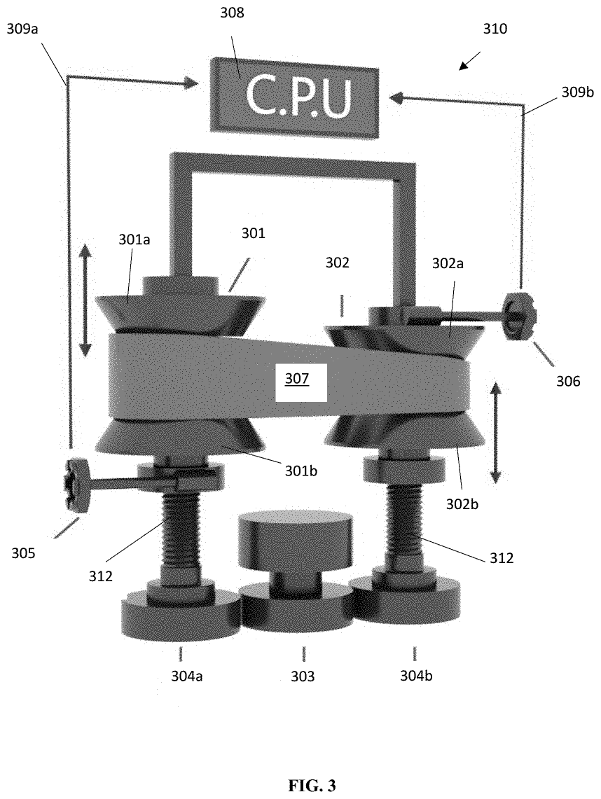

Additionally, the CVT system 110 has a central processing unit (CPU) 108. The CPU 108 being programed to send a signal to the motor 103 to initiate the transmission. Moreover, the motor 103 rotates the disks 104a, 104b according to the CPU (“controller”) 108 input. Thus, the threaded rods 112 adjust the pulleys 101 and 102 accordingly. The system 110 also limits the heat build-up compared to other motor systems because of the variable diameter pulleys 101, 102. The CPU 108 will be discussed in more detail when referring to FIG. 3.

Furthermore, the continuously variable transmission system 110 has a controller (“CPU”) programed to signal a motor 103 to adjust the first adjustable pulley 101 and second adjustable pulley 102 according to a user input. The continuously variable transmission system 110 may also have a plurality of sensors adapted to monitor the first adjustable pulley 101 and second adjustable pulley 102. For example, the sensors may be placed at the driveshafts 105, 106 and the motor 103.

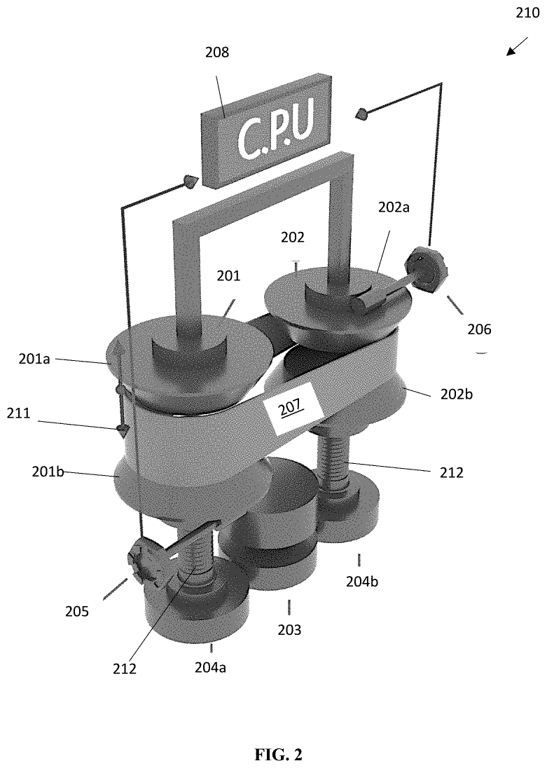

FIG. 2 illustrates the side perspective view of a continuously variable transmission (CVT) system 210, according to an aspect. As shown, the CVT system 210 is an assembly of two diameter changing pulleys 201 and 202, where pulley 201 is the primary pulley and is directly connected to a motor (not shown) via a driveshaft 205. The driveshaft 205 is monitored by an end coder and signals are sent to CPU, which is the primary signal. The pulley 202 is a driven pulley, and it is connected to wheels (not shown) via driveshaft 206. The driveshaft 206 is also monitored by an end coder and signals are sent to the CPU. The gear ratio is changed when the motor 203 rotates threaded rods 212. The threaded rods 212 push outer disk in pulley 201 and inner disk in pulley 202 causing them to rotate and change diameter accordingly. Once the disks 204a and 204b rotate the corresponding pulleys 201 and 202 adjust to the proper diameter due to the threaded rod 212 increasing and decreasing the space between pulley components. As shown, the pulleys 201 and 202 have two conical halves 201a, 202a and 201b, 202b. The two pulleys 201 and 202, as shown, have conical halves each having a top half 201a, 202a and a bottom half 201b, 202b. As described herein, the conical halves 201a, 202a and 201b, 202b move towards and away from each other, respectively, allowing for a change in pulley diameter, depicted by arrow 211.

While the diameter changes on each pulley 201 and 202 may occur simultaneously, the belt 207 rotates faster or slower with the pulleys 201 and 202 depending on the CVT system 210 mode. Thus, the motion in the motor (not shown) initiates motion in the wheels (not shown), by the CVT system 210. For example, a mode may be a high-speed setting or may be a high torque setting based on the user's input into the CPU 208. Thus, when the driveshafts 205 and 206 rotate the from the motor and cause the wheels to rotate, respectively, the system may travel forward. The CVT system may allow for more modes due to the varying pulley diameter sizes. Moreover, the CPU may have more modes to coincide with the variety of modes of the pulleys 201 and 202. For example, the CPU may have a preset mode for high-speed travel.

Currently, motors utilizing gear transmissions usually have to change gears causing a rough ride. These motor and transmission combinations also have a large heat build-up, which can destroy the motor components over time. Additionally, current continuously variable transmissions (CVT) are controlled by centrifugal force and need high rotations per minute, thus cannot operate in numerous situations. Moreover, CVT motors usually cannot operate in manual (non-electric) mode. Motors utilizing a CVT transmission system also are known to cause battery life issues due to the increase of heat in the system. Also, current motors utilizing a CVT transmission systems cannot adapt to non-adjusting components, such as a pulley not adjusting to the correct diameter for the gear like setting.

As described herein, the continuously variable transmission system 210 having a first adjustable pulley and a second adjustable pulley; a belt being around an outer surface of both the first adjustable pulley and the second adjustable pulley allowing the belt 207 to rotate around the first and second pulleys 201, 202 is described herein. The CPU 208 may be programed to signal a motor to adjust the first disk 204a and second disk 204b, wherein both the first disk 204a and the second disk 204b rotate, thus adjusting the first adjustable pulley 201 and second adjustable pulley 202. Furthermore, the first threaded rod 212, coupled to the first disk 204a, adapted to adjust the first adjustable pulley 201 and a second threaded rod 212, coupled to the second disk 204b, adapted to adjust the second adjustable pulley 202. Additionally, the first driveshaft (“input driveshaft”) 205 may be adapted to connect to a car motor. And the second driveshaft (“output driveshaft”) 206 may be adapted to connect to a car wheel set.

FIG. 3 illustrates the side perspective view of a continuously variable transmission (CVT) system 310, according to an aspect. Additionally, the CVT system 310 connects to a CPU (“controller”) 308. The CPU 308 being programed to send signals to the motor. For example, a signal travels from the shaft 305 to the CPU as depicted by the arrow 309a. In another example, a signal travels from the shaft 306 to the CPU as depicted by the arrow 309b. These signals 309a and 309b inform the CPU 308 of various functions. For example, the signals may relay information such as information from the input driveshaft 305, which may be connected to a motor (not shown), to the CPU 308. This information may be, for example, a speed increase in the motor, thus the CPU 308 may send a signal to the motor 303 to adjust the disks 304a and 304b accordingly to adjust the diameter of the pulleys 301 and 302 with the belt 307 around the pulleys outer surface.

Additionally, the controller 308 is programmed to receive inputs and send output signals. The controller 308 receives the signal from the motor (not shown) and wheels (not shown) through driveshafts 305 and 306, respectively. The controller 308 also receives input signals from the user from, for example, user presets or the current motor (not shown) input. The controller then compares the current signal data from the motor (not shown) and wheels (not shown) to the desired input signal data from the user. The controller 308 may then calculate the difference between the signals to determine the adjustments that need to me made to the system. Furthermore, the controller 308 determines the ratio of the diameters of the two pulleys based on the speed or desired user input. Once the controller 308 determines the necessary adjustments, the controller 308 may send a signal to the motor 303 to adjust the disks 304a and 304b accordingly. For example, the controller 308 may determine how fast each element is currently moving and compare to the desired inputs. As another example, if the speed needs to be increased the controller 308 would send a signal to the motor 303 to rotate the motor 303 in a direction wherein the diameter of the first pulley 301 would increase. It should be understood that for example, when the speed needs to be increased, the first pulley would increase, and the second pulley diameter decrease.

The motor 303 rotates the disks 304a and 304b according to the CPU 308 input. Thus, the threaded rods 312 adjust the pulleys 301 and 302 accordingly. For example, input shaft 305 may have a monitoring signal and coder signal, which travels to CPU 308 for the speed adjustment. The output shaft may also have a monitoring signal and a coder signal, which travels to the CPU 308 to compare the central speed control motor (“motor”) 304, gears, and threaded shafts.

Moreover, the motor 303 receives a signal from the control 308 to rotate the disks 304a and 304b. The motor 303 may always be engaged with both disks 304a and 304b, thus when the motor rotates the disks 304a and 304b rotate in their respective directions. For example, the disks 304a and 304b rotate outward from the motor 303, thus the corresponding threaded rod 312 would also rotate, further allowing the pulleys 301, 302 to move closer or further apart. As an example, top half 301a and bottom half 301b would move closer together creating a larger diameter, while the top half 302a and a bottom half 302b move further apart creating a smaller diameter. Each pulley half 301a, 301b, 302a, 302b may move along the threaded rods 312 as determined by the controller and the corresponding motor 303 movement. Additionally, the motor 303 may rotate the disks 304a and 304b, for example, in a forward direction and the disks 304a and 304b may rotate outward, or in a reverse direction and the disks 304a and 304b may rotate inward.

As another example, the CVT system may be continuously monitored by the CPU and, for example, if one signal input requires an adjustment to the pulleys 301, 302 and the other fails to adjust, the motor 303 rotates threaded rods 312 via disks (“gears”) 304a and 304b to adjust pulleys 301 and 302 to move in or out with the speed maintained. The CPU 308 may allow for the continuous smooth transitions that are seamless, while typical motors have to change gears and the ride is rough. Additionally, the CPU 308 may allow minimal heat build-up, thus not destroying component parts as typical motors do.

The controller 308 may be programed to receive an input signal and send an output signal to the motor 303 to adjust a first disk 304a and a second disk 304b. While the input signal being adapted to travel from both the first and second driveshaft 305 and 306 to the CPU 308, and the output signal adapted to travel from the controller 308 to the motor. Thus, to change the diameter of the pulleys 301, 302, the first disk 304a rotates, therefore adjusting both the first top half 301a and the first bottom half 301b of the first pulley 301 along the first threaded rod 312. And the second disk 304b rotates, therefore adjusting both the second top half 302a and the second bottom half 302b of the second pulley 302 along the second threaded rod 312.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A continuously variable transmission system comprising:
a first driveshaft coupled to a first threaded rod attached to a first pulley, the first pulley having a first top half, a first bottom half, and a first varying diameter;
a second driveshaft coupled to a second threaded rod attached to a second pulley, the second pulley having a second top half, a second bottom half, and a second varying diameter;
a belt being around an outer surface of both the first and the second pulley;
a controller programed to receive an input signal and send an output signal to a motor to adjust a first disk and a second disk;
the input signal adapted to travel from both the first and second driveshaft to the controller, and the output signal adapted to travel from the controller to the motor;
wherein the first disk rotates, thus adjusting both the top half and the bottom half of the first pulley along the first threaded rod; and
wherein the second disk rotates, thus adjusting both the top half and the bottom half of the second pulley along the second threaded rod.

2. The system of claim 1, wherein the first driveshaft is adapted to connect to a car motor.

3. The system of claim 1, wherein the second driveshaft is adapted to connect to a car wheel set.

4. The system of claim 1, wherein the first pulley and the second pulley are attached by a rod.

5. The system of claim 1, wherein the controller is adapted to receive an input mode from a user.

6. The system of claim 5, wherein the input mode is a high-speed mode.

7. A continuously variable transmission system comprising:
a first adjustable pulley and a second adjustable pulley;
a belt being around an outer surface of both the first adjustable pulley and the second adjustable pulley;
a controller programed to signal a motor to adjust a first disk and a second disk,
wherein both the first disk and the second disk rotate, thus adjusting the first adjustable pulley and second adjustable pulley.

8. The system of claim 7, further comprising a first threaded rod, coupled to the first disk, adapted to adjust the first adjustable pulley and a second threaded rod, coupled to the second disk, adapted to adjust the second adjustable pulley.

9. The system of claim 7, wherein the first driveshaft is adapted to connect to a car motor.

10. The system of claim 7, wherein the second driveshaft is adapted to connect to a car wheel set.

11. The system of claim 7, wherein both the first and second adjustable pulleys are two conical halves.

12. The system of claim 7, wherein the controller has a preset mode for high-speed travel.

13. The system of claim 1, wherein the CPU has a preset mode for high torque travel.

14. A continuously variable transmission system comprising:
a first adjustable pulley having a first varying diameter and a second adjustable pulley having a second varying diameter;
a belt being around an outer surface of both the first and the second pulley; and
a motor adapted to adjust a first disk and a second disk, wherein both the first disk and the second disk rotate, thus adjusting the first varying diameter of the first adjustable pulley and the second varying diameter of the second adjustable pulley according to a user input.

15. The system of claim 13, further comprising a plurality of sensors adapted to monitor the first adjustable pulley and second adjustable pulley.

16. The system of claim 13, wherein both the first and second adjustable pulleys are two conical halves.

17. The system of claim 13, wherein the user input is a high torque preset.
